(19) United States
(12) Patent Application Publication
(10) Pub. No.: US 2008/0014306 A1
(43) Pub. Date: Jan. 17, 2008

(54) PRESERVING COMPOSITION AND PRODUCT FOR HARVESTING FRUITS AND VEGETABLES, AND METHOD FOR ITS USE

(76) Inventor: Gaston Garcia CASTRO, Santiago (CL)

Correspondence Address: HASSE & NESBITT LLC, 8837 CHAPEL SQUARE DRIVE, SUITE C, CINCINNATI, OH, 45249, US

(21) Appl. No.: 11/769,452

(22) Filed: Jun. 27, 2007

(30) Foreign Application Priority Data
Jun. 27, 2006 (CL) CL 1651/2006

(51) Int. Cl. A23B 7/00; A23B 7/08; A23B 7/10; A23B 7/153; A23L 1/30; A23L 1/302; A23L 1/303; A23L 1/304; A23L 1/305; A23L 3/34; A23L 3/3454

(52) U.S. Cl. 426/73; 426/115; 426/133; 426/323; 426/532; 426/648; 426/654; 426/656; 426/658; 426/72; 426/74

(57) ABSTRACT

A composition, method and system that activates the natural physiological mechanisms of live produce (fruits and vegetables), which work systemically and not only externally in one single component of the fruit (the membrane), by activating the produce's physiological and biochemical machinery and/or the physiological structure. The composition is a liquid product to be applied to fruits or vegetables containing at least one nutrient selected from the group consisting of a micronutrient, a macronutrient, and mixtures thereof, a carbohydrate, at least one acid, selected from the group consisting of an organic acid, an inorganic acid, and salts and mixtures thereof, a vitamin, an amino acid, a biocide, and a vegetal hormone or phytohormone. A package or container is configured to contain the composition, and has a means for placing the contained composition in contact with a biologically functional physiological structure of the fruit or vegetable

### FIELD OF THE INVENTION

The present invention relates to a product for preserving the quality of harvested fruits and/or vegetables and to keep the fruit free from plagues, pests or diseases.

### BACKGROUND OF THE INVENTION

While farm produce (fruits and vegetables) is being cultivated, it obtains nutrients, develops, and performs a number of metabolic activities inherent of its life cycle and of the challenges posed by the environment. Some of the mechanisms that produce activates and executes are the actions to defend and maintain the quality and ripening of its parts and components, such as that of fruits. Sometimes, the natural mechanisms may be exceeded by the environment challenges, and the use of agrochemicals or biopesticides should be resorted to, which may help to prevent or treat the pests or diseases affecting the farm produce. When the fruit is harvested, (that is, when it is taken from the cultivation), it is no longer under the protection of the plant innate defense system, but it is subject to the attack of bacteria and/or fungi, as well as to the decay of the live part of a vegetable which is cut off. These can lead to the death of the fruit and/or vegetable.

There are several processes and products used to preserve fruits and vegetables, so that they may keep their quality during harvest, packing and transport, thus arriving to the consumer with an optimal quality level. This translates into a huge technical and economic effort in order to maintain the freshness, smell and aspect of the recently harvested fruit, for days, weeks or even months. In order to achieve such conditions and maintain the quality of the harvested fruit, different maintenance mechanisms have been used, such as a system of frozen deliveries, controlled atmosphere, modified atmosphere, a system of active packing, gases-generating systems and/or a combination or mixture thereof. Notwithstanding this, these systems involve relatively high—and sometimes sophisticated—resources and facilities, which increase costs even further and increase the need for highly qualified human resources. Other available systems involve the relatively controlled gases that are a fungicide and/or fungistatic, which may eventually damage the fruit if generated in excess.

The preservation methods mentioned above do try to keep the fruit in a “just harvested” condition, thus avoiding the features of fruit decay (as ripening, dehydration, color lose, etc.), as would be the case with any portion of vegetable isolated from the plant. Harvested fruits or vegetables are highly vulnerable to the attack of pathogens (fungi and bacteria), and this is why the current preservation methods are based on external means to avoid the decay and to delay the usual and natural mechanisms of decomposition and infestation by pathogens.

In WO9907230 a method is described to keep the fruit fresh and extend the exposure life. To this effect, an aqueous preserving solution for the fruit is provided comprising calcium ions and ascorbate. This solution is applied externally over the fruit, which delays the decay of texture, color, flavor and other qualities, mainly related to the skin of the fruit. The fruit may be stored at temperatures where it does become frozen. .

In the case of WO9923889, which looks for postponing senescence and increasing the ripening and stability of the fruit, also an external solution is applied comprising lysophospholipids. The aim of this solution is to inhibit D phospholypase, which enzyme decays the membrane during senescence. In CN 1543796 a process is described to prevent and cure diseases in the fruit in the post-harvest stage, which consists in submerging or spraying a solution comprising sodium silicate and potassium silicate, and thus it acts externally.

It may be noted that the preservation and care of fruits involve controlling external conditions, rather than trying to keep for as along as possible the freshness conditions characterizing the fruits and vegetables recently harvested. In preserving flowers there are very similar issues to those described above for the case of fruits. Flowers suffer from the attack of such pathogens as bacteria and fungi, in addition to suffer from severe dehydration after being cut, which eventually makes the flowers rapidly wither. But due to the nonedible nature of flowers, the solutions used to fight pathogens are more successful, since chemicals can be used which are otherwise forbidden for use with fruits and vegetables destined for human consumption.

To solve the dehydration problem in flowers, the state of the art is based on providing the market with substances which, once mixed with water, allow the flower to be rehydrated and fed, by taking the necessary nutrients from the water. These kind of solutions (preservers) are described in U.S. Pat. No. 4,349,459; U.S. Pat. No. 3,104,968; U.S. Pat. No. 2,971,292; and U.S. Pat. No. 3,865,569, among others, which in generally disclose aqueous solutions with salts, sugars and preserving agents. U.S. Pat. No. 6,684,605 describes a packages of modified atmosphere developed for plants and flowers, which is an extension of a widely used technique in the fruit-harvesting industry. In the world market, some products are sold with this purpose, such as Floralife and Crysal, among others.

U.S. Pat. No. 3,874,871 describes an aqueous composition that comprises a monosaccharide, an aluminum salt, boric acid and germicides to preserve cut-off flowers.

WO2004066727 describes a method to preserve cut-off flowers during transport where the flowers are placed in a bag with a humid medium, such as jelly, comprising ingredients which mainly preserve the environmental integrity (biocides, antibacterial agents and preserving agents). The main purpose of the method to provide the cut-off flowers with water, so as to keep the turgid nature and qualities of its components.

JP2005104961 describes an agent for maintaining flowers freshness, especially the color of petals, by inhibiting metabolism.

The solutions available in the market for flowers cannot be directly extrapolated to fruits, since the physiological requirements of flowers and fruits are obviously different. Also, since the object of this invention is to preserve fruits and vegetables in a natural way, keeping them suitable for the final consumption by humans, the technical requirements are much stricter than those necessary for flowers.

Also, flowers are offered “fresh” in the market, that is, just cut-off, since there is not a technology developed that allows preserving flowers in good conditions for much time (over 30 days); therefore the preserving agents and moisturizing solutions existing are only to be used at ambient temperature (about 20° C.) and for a short period of time (one week).

When plants are subject to cold they suffer physiological damage: photosynthesis stops, the carbohydrates incorporation is reduced, the protein synthesis is inhibited, and proteolysis starts. All these processes cause what is seen as general withering and later death of the plant. These processes are kept in each compartment of the plant. Thus, when a flower is cut off, the physiological defense processes become activated if tissue is injured. This means that when a rose is cut for instance, at the end of the stem, a quick dehydration of the tissue takes place, as well as a later lignification in order to form a “stopper” preventing nutrient of the stem from being lost and dehydration thereof. The existing flower preserving agents intend to reduce this dehydration and extend the life of flowers.

When a fruit is cut, similar processes are produced to those noticed in flowers, but also different. The type of reaction depends on the kind of fruit being studied. A classification can be made, where, on the one hand, we have those fruits not forming bunches, such as apples, pears, peaches, apricots, just to mention some of them, and those forming bunches, such as blueberries, grapes, berries and tomatoes, for example. This latter group depends on the physiological unit that joins them together.

In the case of grapes, just as an example and in no way being exclusive, the physiological unit is named a stalk or rachis. Through the stalk, grapes receive nutrients, hormones and everything necessary from the vine for the growth and maintenance of the berries. But once the fruit is harvested, this binding to the vine is lost and the natural biological processes of death begin. At the end of the stalk, the vegetal tissue begins to lignify, thus forming a stopper which reduces the loss of water, but which eventually causes the full dehydration of the stalk and then of berries. At that moment, the fruit is susceptible of being attacked by pathogens. Chemical protection from outside the fruit is necessary.

Furthermore with the table grapes, the annual loss produced by pests and decay of the fruit amounts to millions of US dollars. New processes to keep the good quality of the farming produce harvested are needed. Also, with the penetration and acceptance of the organic products, the need and timeliness to provide a natural process for the preservation of fruits and vegetables harvested is noted.

Plants in their natural state develop defense mechanisms against infection from pests, pathogens or physical damage, which reach all its components: roots, stems, branches, leaves, fruits and flowers. But these defense qualities are mainly shown in components of plants presenting a full and active metabolism, which sometimes allow them to have control over ripening. In general, fruits require being joined to their plant to obtain the benefits of systemic defense mechanisms. When the fruit is harvested, cut-off and separated from the plant, their ability to endure pests and diseases is reduced or completely lost, thus translating into a process of decay and death of tissue, which can be noted as a visual decay of fruits and vegetables.

There are several immunological mechanisms in vegetables to defend against pests and diseases, as well as to overcome conditions of environmental stress. One of these natural mechanisms of defense takes place through phytolexins, which are the biological molecules arising as a response to the attack of pathogens (stress) and which act as hormones, thus triggering biochemical systems of activation and generation of new molecules, with all of them being in charge of improving, through different mechanisms, the effect caused by pathogens. When separating the fruit from the tree, these mechanisms of systemic defense end and the fruit decays, being sensitive to the attack of plagues. But in the case of grapes and of fruits in bunches and/or with pedicel, the presence of this structure is an advantage. In the grape bunch, an anatomical structure called a stalk is kept, which maintains the biochemical machinery capacity to sustain the live maintenance of the fruit of which said machinery lacks.

The stalk has everything needed by a plant to keep alive; it is able to carry out photosynthesis and thus to produce the elements or compounds it needs to live. If the stalk is alive and functional, it may generate the necessary substances for the grape being able to defend against the attack of pathogens Also by keeping a healthy functional stalk, which keeps its characteristic green color, it allows the grape showing excellent visual and organoleptic conditions for the final consumer out of increasing the shelf life at the selling place of the corresponding fruit.

Then, the present invention provides a solution to said technical issue, contributing an alternative to keep the fruits and/or vegetables fresh conditions, in particular to keep the stalk (or pedicel) alive, producing a systemic effect which makes use of all physiological and biochemical qualities of this structure, which will look for the optimal conditions both for the fruit and the stalk itself as regards hydration, ripening control and/or color for example. In the case of structures without pedicel, it may be applied through the fruit's skin as an alternative with equivalent results being obtained.

### SUMMARY OF THE INVENTION

The present invention provides a composition, method and system that activates the natural physiological mechanisms of live produce (fruits and vegetables), which work systemically and not only externally in one single component of the fruit (the membrane), by activating the produce's physiological and biochemical machinery and/or the physiological structure.

The present invention provides a liquid product to be applied to fruits or vegetables, which acts systemically on fruits or vegetables, wherein it acts systemically, the liquid product comprising at least three components selected from the group consisting of: at least one nutrient selected from the group consisting of a micronutrient, a macronutrient, and mixtures thereof, a carbohydrate, at least one acid, selected from the group consisting of an organic acid, an inorganic acid, and salts and mixtures thereof, a vitamin, an amino acid, a biocide, and a vegetal hormone.

The present invention also provides a solid or semi-solid product comprising the above liquid product, and a support means selected from the group consisting of a supporting agent and a distribution means, and further selected from the group consisting of a gel-forming agent, a sponge, an absorber selected form the group consisting of coal, sand, cotton, expanded polyethylene, or any other component can absorb or adsorb the liquid product.

The present invention further provides an article for use to preserve vegetal material, comprising: a) a package or container, selected from the group consisting of a capsule, a tube, a tapered, parallelepiped, globular package, and an adhesive patch, configured to contain a composition selected from the group consisting of the liquid product or the solid or semi-solid product, and b) a means for placing the contained composition in contact with a biologically functional physiological structure of a fruit or a vegetable.

The present invention also relates to a method for treating harvested fruit and vegetables to maintain the condition and quality of the fruit or vegetable after harvesting, comprising the steps of:
1) providing an article comprising: a) a package selected from the group consisting of a capsule, a tube, a tapered, parallelepiped, globular package, and an adhesive patch, configured to contain a composition, and b) a means for placing a contained composition in contact with a biologically functional physiological structure of a fruit or a vegetable,
2) providing a composition selected from the liquid product of claim 1, or the solid or semi-solid product of claim 12, and associating the composition and the package wherein the package contains the compositions,
3) harvesting a fruit or vegetable by separating the fruit or vegetable from its plant at a biologically functional physiological structure of the fruit or vegetable; and
4) placing the biologically functional physiological structure of a fruit or a vegetable in contact with the contained composition.

The present invention further provides: a kit of parts comprising at least above described article; a method for preparing a liquid product or solid or semi-solid products, comprising mixing at least one or more, typically at least three or more, of the micro- and macronutrients, carbohydrates, organic and/or inorganic acids, vitamins, amino acids, biocides, vegetal hormones; use of the liquid product to maintain the pedicel of a harvested fruit or vegetable and its immune system, biologically functional, and to maintain its protection against pests attacking the fruit and vegetable after harvesting; use of the article above for insertion therein or applied thereto recently harvested fruits and vegetables in order to maintain the pedicel of a harvested fruit or vegetable and its immune system, biologically functional, and to maintain its protection against pests attacking the fruit and vegetable after harvesting; and of a kit of parts including the article above maintain the pedicel of a harvested fruit or vegetable and its immune system, biologically functional, and to maintain its protection against pests attacking the fruit and vegetable after harvesting.

### DESCRIPTION OF FIGURES

FIG. 1A shows an elevation view of a container of the present invention for containing the formulation of the invention, having a lid, partially sectioned through line 1A-1A of FIG. 1B.

FIG. 1B is a plan view of the container and lid, viewed from line 1B-1B of FIG. 1A, illustrating slits in the lid through which a plant element can be inserted.

FIG. 2 shows a container according to the invention containing the formulation, with the stalk of a grape bunch inserted into the container.

FIG. 3 shows, at harvesting, the devices containing the formulation according onto the grape bunches that are collected in boxes.

FIG. 4 shows the boxed grape bunches.

FIG. 5A shows the appearance of a Thompson Seedless grape bunch and stalk without the formulation-containing containers of the invention.

FIG. 5B shows the appearance of the Thompson Seedless grape bunch and stalk, kept for 30 days with the formulation-containing containers of the invention

FIG. 6A shows the appearance of a Red Globe grape bunch and stalk without the formulation-containing containers.

FIG. 6B shows the appearance of the Red Globe grape bunch and stalk kept for 30 days with the formulation-containing containers.

FIG. 7A shows the appearance of a Thompson Seedless grape bunch and stalk without the formulation-containing container. The grape loosing level exhibited by this control bunch is noticeable.

FIG. 7B shows the appearance of the Thompson Seedless grape bunch and stalk kept for 60 days with the formulation-containing container, which keeps the grapes almost all intact.

FIG. 8A shows the appearance of a Red Globe grape bunch and stalk without the formulation-containing container.

FIG. 8B shows the appearance of the Red Globe grape bunch and stalk which have been kept during 60 days with the formulation-containing container.

FIG. 9 shows a chart of the quality of fruit variation for different formulations and a control.

FIG. 10 shows a perspective view of an alternative embodiment of a container of the present invention.

### DETAILED DESCRIPTION OF THE INVENTION

The present invention relates to a product in a solution, which continuously provides nutrients and hormones to fruits and vegetables that have been cut from the trees or plants which held and supported them, to maintain the basic biochemical functions. The object is to simulate the conditions that the fruit maintains on the tree or plant, but also other conditions of the fruit may be controlled, such as ripening and coloring, just to mention some of them, depending on the additional components added. The use of the product is based on placing the solution in contact with a biologically functional physiological structure of the fruit or vegetable to exert its systemic preserving effect. This structure can be the pedicel or the skin of the fruit or vegetable. For example, in the case of vegetables having a pedicel, it is preferred to place the solution of the present invention in contact with the pedicel of the vegetable When the solution makes contact with the pedicel, the latter remains moisturized and biologically functional, and in the case of the grape with the stalk, to keep the good condition of the fruit and its quality and freshness appearance.

The components comprised by the product of the present invention are selected from the group consisting of at least one essential nutrient selected from the group consisting of a micronutrient, a macronutrient, and mixtures thereof, a carbohydrate, an acid selected from the group consisting of an organic acid, an inorganic acid, and mixtures thereof, an amino acid, and at least one vitamin, in addition to other protecting components such as fungicides, fungistatic, vegetal hormones (also referred to as phytohormones) such as phytolexins, phytoantipcipins and/or their precursors and/or their synthetic equivalents, as well as their inhibitors. More typically, the invention comprises at least three of the components. All these components are useful to provide proper conditions for the fruit to maintain a proper aspect and to prolong the usual mechanisms of survival.

Also, and according to the ingredients incorporated, the activation of the immune system of the pedicel is possible, thus strengthening the innate protection mechanisms against the pests which generally attack the fruits once the fruit is cut. As an example, in the table grape, the natural defense can be increased against Botrytis Cinerea, acid rotting Aspergillus niger, Penicillium, Trichoderma, Mucor, Alternaria, Vericillium, just to mention some, and without limiting them.

This product can be dispensed in a capsule, tube, or any equivalent or similar device that allows containment of the solution (package or deposit chamber), to reduce its evaporation, to insert or approach a portion of the fruit so that it contacts and/or makes use of the components present in the solution An embodiment of the invention may be a tapered, parallelepiped, globular package, or in the form of adhesive patch.

To avoid leaking or falling of the solution from the package or deposit chamber during insertion of or adhesion to the fruit, the following can be incorporated as distribution medium or supporting agent: a gel-forming agent, a sponge, absorbers such as coal, sand, cotton, aerogel, expanded polyethylene or any other components that allow achieving this effect. The condition to be met by the supporting agent is that it must allow for the absorption of all components of the solution, absorbed and/or adsorbed therein, by the fruit or by the anatomic organ leading to it.

The package shall have the dimensions and be conceived in the embodiment required by the fruit and conservation time. The package may be manufactured of organic or inorganic polymers, whether synthetic or natural, preferably biodegradable, with the single condition that it should be inert to the components of the solution, gel, sponge or supporting agent selected, not being limited to the handling of fruits and foodstuffs and resistant to other conditions which the product may undergo as part of the conservation, export or transport process. For instance, the package may be made of polypropylene, low density polyethylene, high density polyethylene, polyesters, polyethylene, polyethylene terephthalate (PET), nylon, polyamides, polystyrene, polylactic acid and its derivatives, silicon, silica, or silicates, paper, starch, polyhydroxyalkanoates, cellulose and its derivatives or a mixture thereof In certain embodiments, also the package may be made of polyvinyl chloride (PVC), cotton, rayon, polyurethane and/or natural or synthetic rubber and/or a mixture thereof.

In an embodiment of the invention, the solution is dispensed in a supporting agent which may be gel, sponge or any supporting agent that allow keeping the solution in the package or deposit chamber, since in this way it provides easy management, maintenance and satisfactory moisturizing qualities for the objects of the present invention and its applications. If a gel is used, this may be made up by gel-forming agents, such as alginates and its derivatives, pectin and its derivatives, agar agar, guar, xantic and arabic gums, gluten, soy protein, caseinate, albumin, hydrophilic rubbers, jelly, dextrine, starch, carboxymethylcellulose, hydroxyethylcellulose, acetyl, methyl and ethyl cellulose, polyacrylic polymers and its copolymers, water-dispersing polymers polyvinyl chloride-derived and acrylate and methacrylate derived polymers. The main characteristics of the gel-forming agent which will act as supporting agent to the present invention, should be: non-toxic for the fruit or consumers, compatible with the other constituents of the invention, and approved by the competent authority for the foreseen uses. Concentrations used vary according to the agent used, but it is preferred in concentrations ranging between 0.5% and 40% p/p, always looking for providing suitable technical conditions to keep the qualities of the agent and not affecting or damaging the part of the fruit in contact with it.

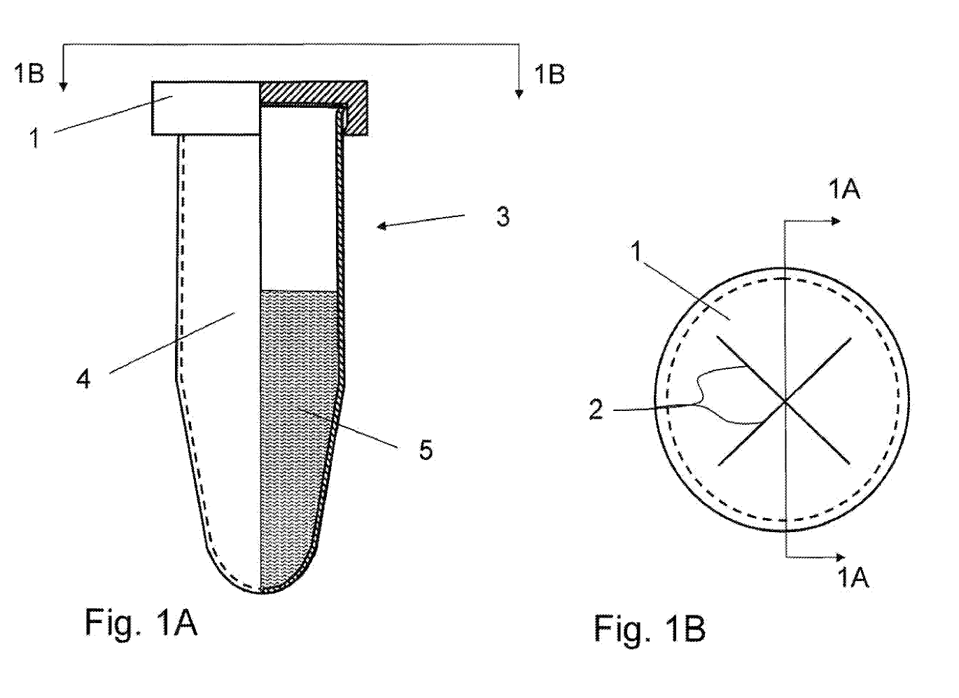

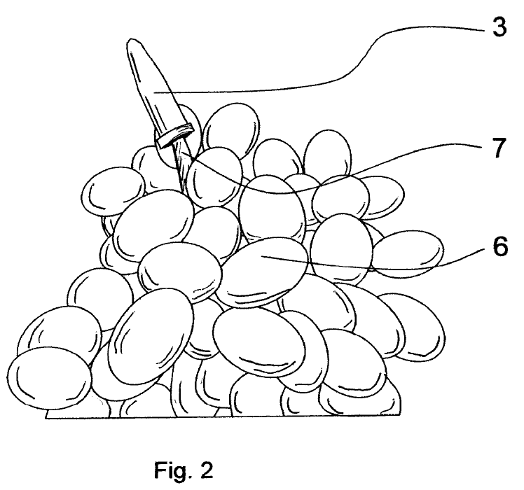

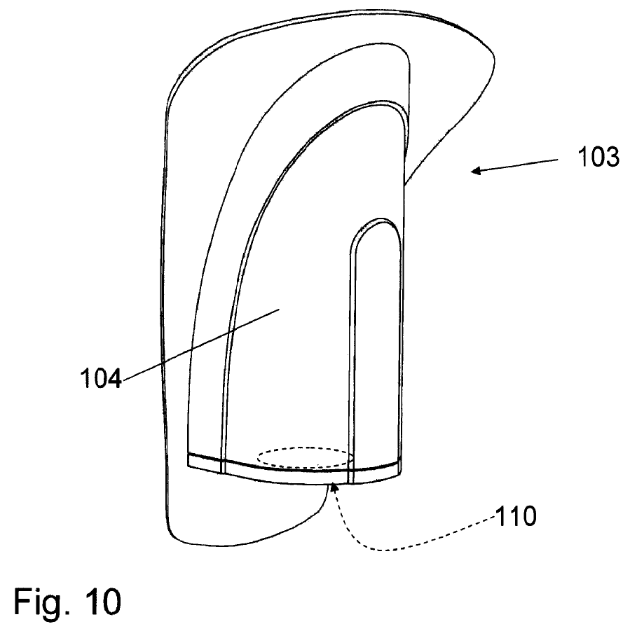

Among the preferred embodiments, as shown in FIGS. 1A and 1B, the container device 3 of the invention corresponds to a tube or package 4 having an opening at one end, and is filled with the solution 5 (or gelled), with a plug or lid 1, or any similar closure, such allows insertion of an end of the fruit's pedicel or stalk in the case of grapes. The lid 1 has a pair of crossing slits 2 through the thickness of the material of the lid, which is sufficiently pliant to form an opening through which the stem of the produce can be inserted, as shown in FIG. 2. A further embodiment of the container is shown in FIG. 10 as container 103 having a container sidewall 104 and an opening 110 in the bottom of the device 103. Another embodiment is an adhesive patch used in contact with the fruit's skin or surface in the cases where there is no pedicel and/or it is not suitable from the physiological, commercial and/or functional point of view to insert the device.

Among the components of the present invention, the micro- and macronutrients corresponding to chemicals preferably can be found, which are selected from the periodic table of elements and corresponding to the alkaline (group 1) and/or alkaline earth (group 2) groups, preferably sodium, potassium, calcium, magnesium, barium and transition metals from groups 7, 8, 11, 12 and 13, preferably manganese, iron, copper, silver, zinc, boron and aluminum. These chemical elements are comprised in a salt form, among which the following are preferred: chloride salt, hypochlorites, chlorites, sulphates, sulphites, metabisulphites, thiosulphates, borates, nitrates, nitrites, phosphates, phosphites, phosphate acids, oxides and iodide. These salts are contained in the solution in concentrations in a range between 0.003 g/L and 40 g/l, particularly expressed as the cation.

Other components of the present invention correspond to the organic and/or inorganic acids and/or a mixture thereof, which provides the proper pH in order to achieve an optimal absorption by the fruit or vegetable harvested of the components provided by the solution of the present invention. Preferably, acids selected from boric, malic, benzoic acid, and its derivatives are used, as well as citric, tartaric acids and its derivatives, salicylic, ascorbic acids and its derivatives, fumaric acid and its derivatives, hydrochloric, hypochlorous, phosphoric and sulphuric acid, just to mention some. Since the presence of acids is important for the proper response of the plant, the concentration at which it is applied is fundamental and it may vary between 0.001 g/L and 10 g/L, preferably between 0.001 g/L and 3 g/L. In order to keep pH between 3 and 8 units, preferably between 4 and 6, buffering systems are used, for keeping the system within the specified range, being preferable citric acid/sodium citrate, acetic acid/sodium acetate, phosphate, potassium diacid/acid phosphate of sodium and other ones known for their abbreviations, such as 2-(N-morpholino)ethanesulfonic acid (MES), Bis-(2-hydroxyethyl)-imino-tris-(hydroxy methyl)-methane (Bis-Tris), N-(2-Acetamido)iminodiacetic Acid (ADA), 3-(N-morpholino)propanesulfonic acid (MOPS) and 4-(2-hydroxyethyl)-1-piperazineethanesulfonic acid (HEPES).

Other relevant components in the present invention correspond to the carbohydrates comprised in the solution. As carbohydrates, sugars such as poly and monosaccharides are used, which generate pentoses and hexoses. Preferably sucrose, mannitol, glucose, maltose, fructose, galactose and mannose are used in concentrations varying between I g/L and 70 g/L, with the preferred concentration being between 15 g/L and 70 g/L.

One of the major complications of fruits during the post-harvest handling and treatment process, in particular for grapes, are fungi, since the solution is a nutrient-rich medium, which may act as incubating medium for pests. Then, the presence of fungicides and fungistatic is important in the present invention. The preferred fungistatic and fungicide agents may be selected from organic and/or inorganic salts or a mixture thereof. Derivatives from metabisulphites, borates, phosphates, benzoates, ascorbates, hypochlorites and tartrates or mixtures thereof are preferred. Also the use of antibiotics is advantageous, such as derivatives of penicillins and tetracyclines or mixtures thereof. The amount of these components varies between 0.001 g/L and 10 g/L, preferably 0.004 g/L and 3 g/L.

The phytohormones are a component of the present invention which may provide important benefits to the fruit preserved using the development explained herein. In this sense, the preferred phytohormones may be selected from phytoalexins and/or phytoanticipins and/or its synthetic and/or natural derivatives and/or its direct and indirect precursors, as well as its synthetic and/or natural analogues. In its most preferred embodiment, compounds such as giberelic acid, jasmonic acid and its derivatives are used, as well as salicylic acid, absicic acid, sistemine, GASA, β.amino butyric acid, cytokine, kinetine, zeatine and its derivatives, ethylene, auxins and brassinoesteroids and/or its synthetic equivalents, as well as its natural and/or synthetic inhibitors. Concentrations between 1 μM and 100 mM are preferred.

Also the essential amino acids are necessary, thus the proteins and other substances de novo synthesis, required by fruits and vegetables, must be kept. Preferred concentrations of amino acids vary between 0.01 μM and 10 mM.

Also vitamins are necessary, among which vitamin B1, vitamin B2, vitamin A, vitamin E, vitamin D are necessary, and their preferred concentrations are between 10 μg/L and 500 mg/L.

An embodiment of the present invention consists in the kit or kits of parts, where a case or distribution means are made up of one or a set of different devices or packages containing the components of the invention. A preferred kit is that made up of a device formed by a package or patch, which incorporates the liquid, solid or semi-solid medium containing the components according to the present invention. Another embodiment is a kit where a package is separately available with the liquid solution of the invention as previously described; and finally the package used in the invention according to the description and conditions described herein.

A normally skilled person in the art may understand that the properties and virtues of the liquid, solid or semi-solid medium extend to the other inventions, devices and kits, already described in the present invention. Then, the present invention is useful to keep the pedicel in good conditions and moisturized, in addition to activate the pedicel's immune system and/or the metabolism of a harvested fruit or vegetable's skin, and to achieve protection against the pests which affect the fruit once cut. Preferably, the present invention achieve an increased natural defense against Botrytis Cinerea, acid rotting, Aspergillus niger, Penicillium, Alternaria, Trichoderma, Mucor, Vericillium in grapes.

The liquid, solid and semi-solid compositions of the present invention may be prepared by mixing the different components making up the invention, and in particular by mixing those components selected to form the preferred products of the invention.

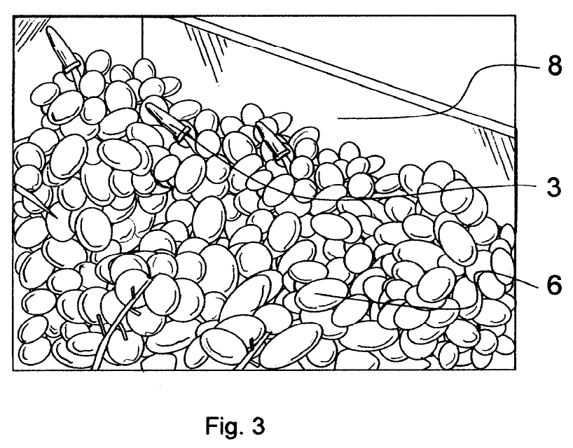

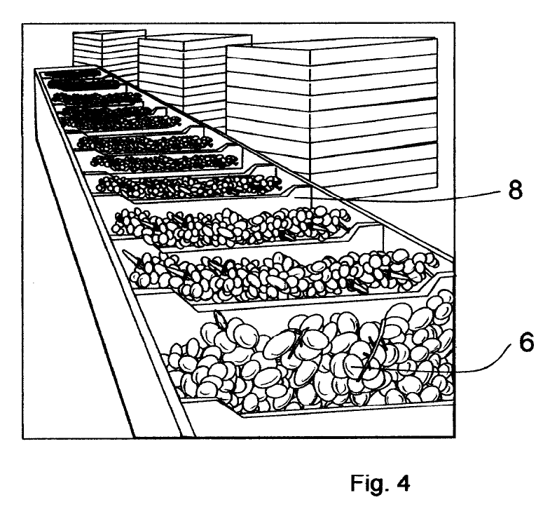

One embodiment to apply the present invention to fruits or vegetables consists, immediately after cutting the fruit from the plant, is to insert the cut end of said fruit's pedicel in a device containing the corresponding liquid, solid or semi-solid agent, so that the device may be suitable and adjusted to the physiological requirements and dimensions of the fruit or vegetable, further being consistent with the later treatment to be applied to the fruit or vegetable. FIG. 3 shows, the devices containing the formulation that are applied at harvesting onto the stem of a grape bunch, which are then collected in boxes as shown in FIG. 4.

If an adhesive patch is to be applied with the product, it should be preferably applied immediately after harvest. Also, the device can be applied as a patch once the fruit or vegetable have been deprived from the anatomical structure which kept it joined to the corresponding plant or tree.

Floral preserving solutions are designed to face the short-term physiological needs of flowers and to keep them at ambient temperature. Floral preserving agents are in general made up of the carbohydrates required to hold the flower's energy consumption, that is, to feed it. The single function described of carbohydrates is to be a source of energy for flowers. This is why its concentration varies between 10 g/L and 45 g/L. This requirement is calculated on the basis of flowers needs at ambient temperature and according to the type of carbohydrates used. It is well known that energy requirements of a living being vary dramatically when measured at normal temperature conditions (25° C.) and when subject to the cold which is necessary for preservation, as for example in the case of fruit and vegetable refrigeration from their origin to final destination in other countries.

Fruits and vegetables are subject to the necessary refrigeration temperatures for preservation and conservation between 0° C. and 15° C. according to the applicable species. Under these conditions, the energy requirements are different from those necessary at room temperature. Also under thermal stress conditions, sugars have a physiological function other than the usual one, since they participate in cellular cryoprotection. In fact, it has been noted that sugars surround water molecules, thus preventing them forming ice crystals, which damage cells with their tips. Thus, under cold conditions, the requirements of carbohydrates, specifically sugars, have a double function and their incorporation in larger amounts is necessary. Also, under cold-stress conditions, “anti-freezing proteins” are generated, which along with sugars promote cellular protection. In order to strengthen this action, the present invention can incorporate phytohormones, which boost this property, such as abscicic acid that promotes the acclimatization of plants to cold stress.

Finally it has been noted that at protein synthesis level there is a relation between the cold-stress conditions and those generated by the attack of pathogens (Taiz Zeiger, Plant Physiology 2002). The invention strengthens the natural defense of fruits and provides time to promote acclimatization to cold, extending the preservation of quality in the fruits using the invention by activating the existing biochemical systems.

The preferred forms of application of the present invention consist in: a) placing the package with a gel of the composition already described on the fruit's pedicel (the stalk in the case of grapes). This placing should be done immediately after the fruit has been cut from the vine or the corresponding plant in the case of another fruit. Thus, the fruit is protected against dehydration and the cell death processes are inhibited from the very first moment, which is very important in order to get the maximum benefit for the fruit when using the inventions; and/or b) applying a patch containing the solution in liquid, solid or semi-solid condition over the skin of fruits and vegetables without a functional pedicel. This patch may be applied immediately during harvest or packaging process.

### EXAMPLES

### Example 1

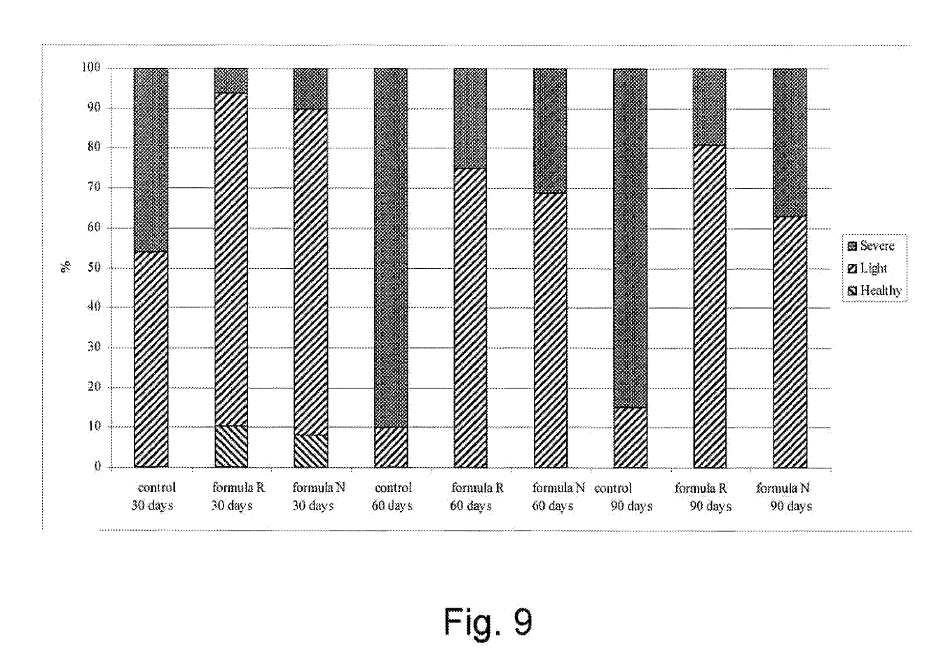

A typical preparation of the present invention consists in adding 100 ml of water, 2 g MgCl₂, 2 g glucose, 0.006 g HBO₃, 0.2 g NaNO₃ and 0.5 g KHPO₄. The mixture is resulting in a clear solution. Then, 3.2 g of xantic gum are added and a thick solution is obtained. The solution is provided and incorporated into a capsule according to the present invention. The result of using this formula can be seen in FIG. 9 and corresponds to the R formula.

### Example 2

To 100 ml of water, 1 g CaCl₂, 4 g glucose, 0,3 g HBO₃, 0,3 g NaNO₃, 0,2 g KHPO₄, 0,1 g K₂SO₄, 0,2 g KNO₃ and 2 ml of a 10 mM salicylic acid solution, are added. The mixture is stirred and a clear solution is obtained. Then, 2.9 g of guar gum is added. The resulting solution is incorporated to a capsule according to the present invention. FIG. 9 shows the N formula.

### Example 3

Any of the preparations already mentioned is used and applied over table grapes of the Thompson Seedless and Red Globe variety. Once the grape is cut from the vine, the device is immediately inserted into the stalk end and grapes are packaged as usual. Then, they are stored in a cold chamber between 0° C. and 2° C. for 30, 60 and 90 days to finally assess the conservation conditions. In parallel with this, grapes harvested to which the device containing the solution according to the present invention has not been applied, are subject to the same process and conditions. This process and conditions to which grapes are subjected to is identical to the process used commercially to store and send export fruit to final destinations.

The grape stored at the conditions previously mentioned, with and without the device of the present invention, was analyzed after 30, 60 and 90 days in order to check the effect of the invention on the visual quality conditions of fruit and to assess the improvement and/or maintenance of the organoleptic qualities of the fruit.

In order to assess the effect of devices on the fruit conservation, it is noted that the condition shown by the stalk after the treatment, classifying its condition according to damage (dehydration) in: Healthy (no dehydration), Light (light dehydration) and Severe (strong dehydration).

In Table 1 the results are shown obtained in trials where the formulae indicated in examples 1 and 2 of the present invention were used. They are expressed as a percentage (%) of total samples represented in FIG. 9.

TABLE 1

| | Condition | Healthy | Light | Severe |
|---|---|---|---|---|
| 30 Days | Control | 0 | 54 | 46 |
| | Formula R | 10.4 | 83.3 | 6.3 |
| | Formula N | 8 | 82 | 10 |
| 60 Days | Control | 0 | 10 | 90 |
| | Formula R | 0 | 75 | 25 |
| | Formula N | 0 | 69 | 31 |
| 90 Days | Control | 0 | 15 | 85 |
| | Formula K | 0 | 81 | 19 |
| | Formula N | 0 | 63 | 37 |

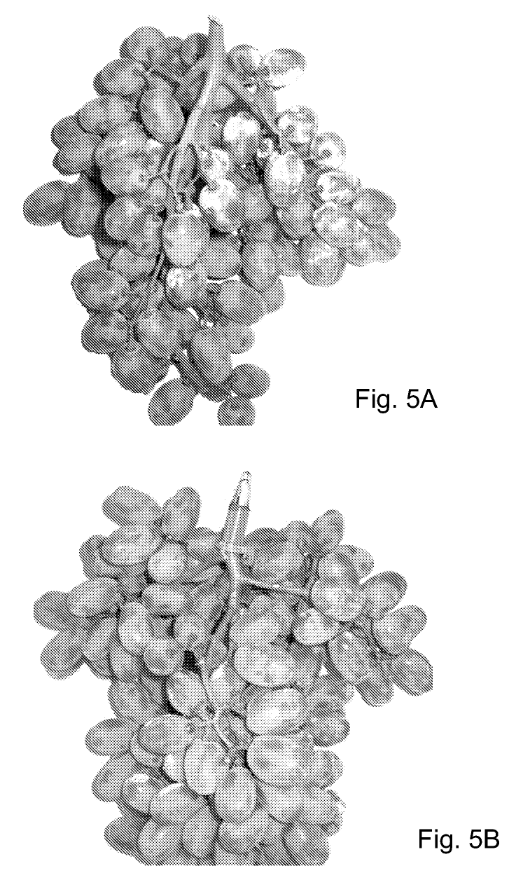

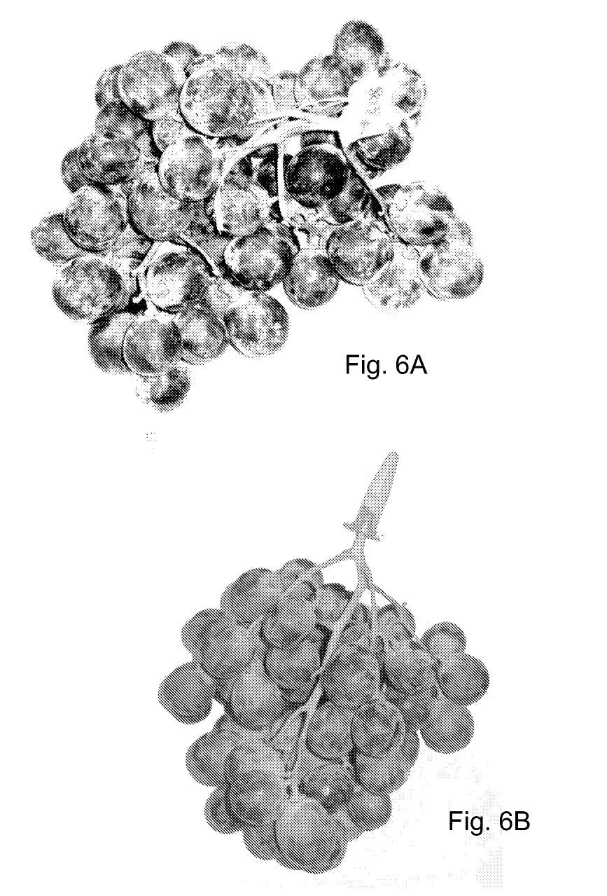

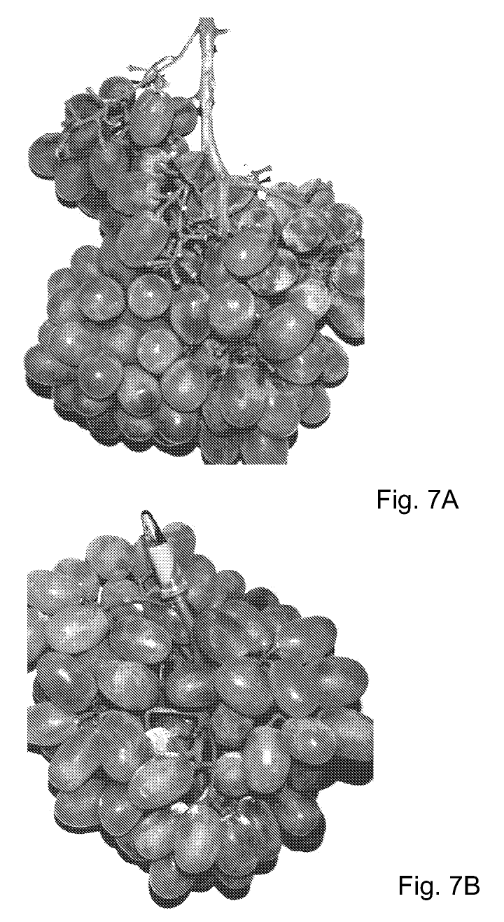

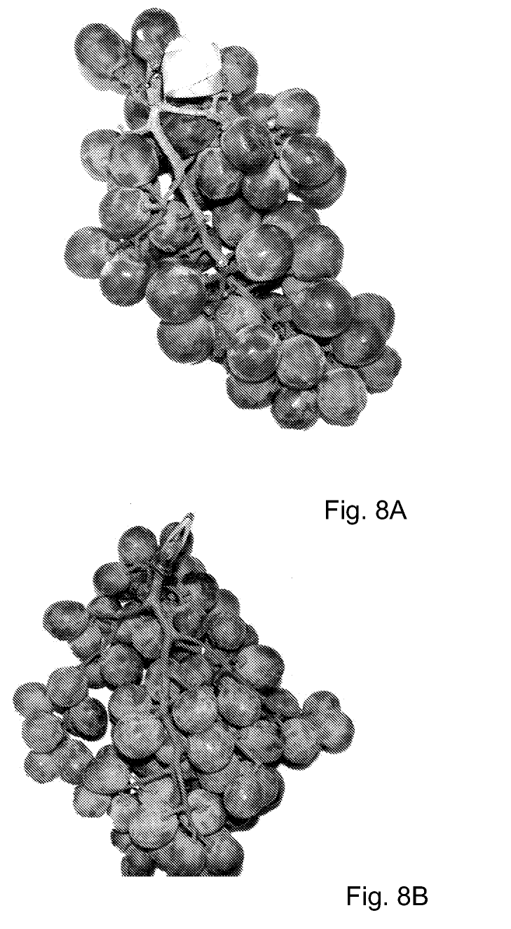

In FIG. 9, according to the results obtained, it is noted that with the device of the present invention after a 30 days storage period at the aforementioned conditions, the healthy and light condition of grapes is kept between 90% and 93.7% (N and R formulae) as compared with 54% of control (grape without the device). When analyzing the data for the 60 days storage period, the benefit given by the invention is greater, since it preserves in good conditions between 69% and 75% of fruit, as compared with the control ones, which exhibits only 10% of bunches in good conditions. Finally, when assessing the fruit condition after the 90 days storage period, the same trend as observed for the data at the 60 days period is kept, where 70% of fruit as average stored is kept at proper conditions, only with a light decay, as compared with the fruit stored at normal conditions where about 90% shows severe decay. FIG. 5A and B, 6A and B, 7A and B, and 8A and B show photographs of the results obtained when using the present invention on table grapes.

1. A liquid product to be applied to fruits or vegetables, which acts systemically on fruits or vegetables, the liquid product comprising at least three components selected from the group consisting of: at least one nutrient selected from the group consisting of a micronutrient, a macronutrient, and mixtures thereof, a carbohydrate, at least one acid selected from the group consisting of an organic acid, an inorganic acid, and salts and mixtures thereof, a vitamin, an amino acid, a biocide, and a vegetal hormone.

2. The liquid product according to claim 1, comprising the at least one nutrient, the carbohydrate, and the at least one acid.

3. The liquid product according to claim 2, further comprising the vegetal hormone, the biocide, and mixtures thereof.

4. The liquid product according to claim 2, wherein the at least one nutrient comprises a chemical element selected from the group consisting of sodium, potassium, calcium, magnesium, barium, manganese, iron, copper, silver, zinc, boron and aluminum, and wherein the chemical elements is contributed in the form of at least one salt selected from the group consisting a chloride, a hypochlorite, a chlorite, a sulphate, a sulphite, a metabisulphite, a thiosulphate, a borate, a nitrate, a nitrite, a phosphate, a phosphite, an acid phosphate, an oxide and an iodide.

5. The liquid product according to claim 4, wherein the concentration of the at least one nutrient salt is between 0.003 g/L and 40 g/l, expressed as the cation.

6. The liquid product according to claim 2, wherein the at least one acid is selected from the group consisting of boric acid, malic acid, benzoic acid and its derivatives, citric acid, tartaric acid and its derivatives, salicylic acid, ascorbic acid and its derivatives, fumaric acid and its derivatives, hydrochloric acid, hypochlorous acid, phosphoric acid, and sulphuric acid, and where the concentration is between 0.001 g/L and 10 g/L.

7. The liquid product according to claim 6, wherein the at least one acid is selected from the group consisting of a mixture of citric acid and sodium citrate, a mixture of acetic acid and sodium acetate, a phosphate, a mixture of potassium diacid and an acid phosphate of sodium, MES, Bis-Tris, ADA, MOPS and HEPES, wherein the composition of the liquid product achieves a pH value between 3-8.

8. The liquid product according to claim 2, wherein the carbohydrate is selected from the group consisting of a polysaccharide, a monosaccharides which generate a pentose or a hexose, sucrose, mannitol, glucose, maltose, fructose, galactose and mannose, and wherein the concentration of the carbohydrate in the product is between 1 g/L and 70 g/L.

9. The liquid product according to claim 1, wherein the biocide is selected form the group consisting of a fungicide, a fungistatic agent, a derivative of penicillin, and tetracyclines, and mixtures thereof, and where the amount of these components on the product is between 0.001 g/L and 10 g/L.

10. The liquid product according to claim 1, wherein the vegetal hormone is selected from the group consisting of giberelic acid, jasmonic acid and its derivatives, salicylic acid, absicic acid, sistemine, GASA, β-amino butyric acid, cytokine, kinetine, zeatine and its derivatives, auxin, brassinoesteroid, and mixtures thereof, and wherein the concentration is product is between 1 μm and 100 mM.

11. The liquid product according to claim 2, comprising at least one of the essential amino acids at a level between 0.01 μm and 10 mM, and wherein the at vitamin is selected from the group consisting of vitamin B1, vitamin B2, vitamin A, vitamin E, vitamin D, and having a concentration between 10 μg/L and 500 mg/L.

12. A solid or semi-solid product comprising a liquid product according to claim 1, and a support means selected from the group consisting of a supporting agent and a distribution means, and further selected from the group consisting of a gel-forming agent, a sponge, an absorber selected form the group consisting of coal, sand, cotton, expanded polyethylene, or any other component can absorb or adsorb the liquid product.

13. The solid or semi-solid product according to claim 12, wherein the gel-forming agent is selected from the group consisting of alginate and its derivatives, pectin and its derivatives, agar agar, guar, xantic and arabic gums, gluten, soy protein, caseinate, albumin, hydrophil rubbers, jelly, dextrine, starch, carboximethylcellulose, hydroxyethylcellulose, acetil, methyl cellulose, ethyl cellulose, a polyacrylic polymer, a polyacrylic copolymer, a water-dispersing polymer derived from polyvinyl chloride, and a polymer derived from acrylate and methacrylate, and wherein the gel-forming agent has aconcentration between 0.5% and 40%.

14. An article for use to preserve vegetal material, comprising:
a. a package, selected from the group consisting of a capsule, a tube, a tapered, parallelepiped, globular package, and an adhesive patch, configured to contain a composition selected from the liquid product according to claim 1 and
b. a means for placing the contained composition in contact with a biologically functional physiological structure of a fruit or a vegetable.

15. The article according to claim 14 wherein the package is made of a material selected from the group consisting of polypropylene, low density polyethylene, high density polyethylene, polyester, polyethylene terephthalate (PET), nylon, polyamide, polystyrene, polylactic acid and its derivatives, polyvinyl chloride (PVC), silicon, silica, a silicate, paper, starch, polyhydroxyalkanoates, cellulose and its derivatives, cotton, rayon, polyurethane, natural rubber, synthetic rubber, and mixtures thereof.

16. A method for treating harvested fruit and vegetables to maintain the condition and quality of the fruit or vegetable after harvesting, comprising the steps of:
1) providing an article comprising:
a) a package selected from the group consisting of a capsule, a tube, a tapered, parallelepiped, globular package, and an adhesive patch, configured to contain a composition, and
b) a means for placing a contained composition in contact with a biologically functional physiological structure of a fruit or a vegetable,
2) providing a composition selected from the liquid product of claim 1, and associating the composition and the package wherein the package contains the compositions,
3) harvesting a fruit or vegetable by separating the fruit or vegetable from its plant at a biologically functional physiological structure of the fruit or vegetable; and
4) placing the biologically functional physiological structure of a fruit or a vegetable in contact with the contained composition.
